(19) United States
(12) Patent Application Publication
(10) Pub. No.: US 2026/0162318 A1
(43) Pub. Date: Jun. 11, 2026

(54) IMAGE PROCESSING APPARATUS, METHOD, AND PROGRAM

(71) Applicant: FUJIFILM Corporation, Tokyo (JP)

(72) Inventor: Kei YAMAJI, Saitama (JP)

(73) Assignee: FUJIFILM Corporation, Tokyo (JP)

(21) Appl. No.: 19/315,439

(22) Filed: Aug. 29, 2025

Related U.S. Application Data
(63) Continuation of application No. PCT/JP2024/004061, filed on Feb. 7, 2024.

(30) Foreign Application Priority Data
Mar. 2, 2023 (JP) 2023-032060

(51) Int. Cl. G06T 11/00

(52) U.S. Cl. CPC G06T 11/00

(57) ABSTRACT

An image processing apparatus, a method, and a program capable of generating an appealing and attractive image are provided. A server (10) functioning as an image processing apparatus includes a processor (12), and a memory (14) storing a program to be executed by the processor (12), in which the processor (12) is configured to acquire a first image including a subject, analyze a scene of the first image, acquire optimal composition corresponding to the scene from an image database (20) based on an analysis result of the analyzed scene, and generate a second image based on an image of the subject and the composition.

### CROSS-REFERENCE TO RELATED APPLICATIONS

The present application is a Continuation of PCT International Application No. PCT/JP2024/004061 filed on Feb. 7, 2024 claiming priority under 35 U.S. C § 119(a) to Japanese Patent Application No. 2023-032060 filed on Mar. 2, 2023. Each of the above applications is hereby expressly incorporated by reference, in its entirety, into the present application.

### BACKGROUND OF THE INVENTION

### 1. Field of the Invention

The present invention relates to an image processing apparatus, a method, and a program, and particularly to a technique for generating an appealing image.

### 2. Description of the Related Art

Recent development in image generation technology may lead to a probability that an image that is appealing compared to an actually captured image can be generated in 5 to 10 years.

JP2017-515345A discloses a technique for selecting a base image desired by a user from a series of images depicting a scene, redisposing an object selected from the series of images on the base image, and generating a new image obtained by compositing the base image and the object. Accordingly, a new image that is not present in the series of images and that is appealing or attractive is generated.

The object targeted by the invention according to JP2017-515345A is a moving object such as a ball, and a position of the object (the ball) to be redisposed is restricted to a position on a moving path of the ball or a position not significantly deviating from the moving path.

In the embodiment of the invention according to JP2017-515345A, in a case where there is an image obtained by imaging a scene in which a golfer hits a golf ball, and a scene in which the golf ball goes into a cup and the golfer strikes a celebration pose is captured, the golf ball is not actually captured in the image of striking the celebration pose.

Therefore, the image in which the golfer striking the celebration pose is captured is used as the base image and is composited with the golf ball at a position designated by the user (for example, a position close to the cup) on the moving path of the golf ball (the moving path in a case where the golf ball goes into the cup) to generate a new image that is originally not present.

### SUMMARY OF THE INVENTION

One embodiment according to the disclosed technology provides an image processing apparatus, a method, and a program capable of generating an appealing and attractive image.

According to a first aspect of the invention, there is provided an image processing apparatus comprising a processor, and a memory storing a program to be executed by the processor, in which the processor is configured to acquire a first image including a subject, analyze a scene of the first image, acquire composition based on an analysis result of the analyzed scene, and generate a second image based on an image of the subject and the composition.

According to a second aspect of the present invention, in the image processing apparatus according to the first aspect, it is preferable that the subject is one or more subjects having an importance degree greater than or equal to a threshold value.

According to a third aspect of the present invention, in the image processing apparatus according to the second aspect, it is preferable that the first image is a first image group.

According to a fourth aspect of the present invention, in the image processing apparatus according to the second aspect, it is preferable that the first image is a first image group of a user, and the importance degree varies depending on the number of images including the same subject, a ratio of an occurrence frequency, or the subject in the first image group.

According to a fifth aspect of the present invention, in the image processing apparatus according to any one of the second aspect to the fourth aspect, it is preferable that different values of the threshold value are set depending on the importance degree.

According to a sixth aspect of the present invention, in the image processing apparatus according to any one of the first aspect to the fifth aspect, it is preferable that the processor is configured to generate the second image by changing a degree of processing for the image of the subject in accordance with an importance degree of the subject.

According to a seventh aspect of the present invention, in the image processing apparatus according to any one of the second aspect to the fifth aspect, it is preferable that a value set for the threshold value is increased as the importance degree of the subject is increased, and the processor is configured to generate the second image by reducing a degree of processing for the image of the subject, as the importance degree of the subject is increased.

According to an eighth aspect of the present invention, in the image processing apparatus according to the third aspect or the fourth aspect, it is preferable that the processor is configured to, in a case where the subject is a person having a high importance degree, generate the image of the subject included in the second image based on a plurality of images of the subject among a plurality of images including the subject included in the first image group.

According to a ninth aspect of the present invention, in the image processing apparatus according to any one of the second aspect to the fifth aspect, it is preferable that, in a case where the subject is a person, different threshold values between a face region and a body region other than the face region of the subject of the first image are set as the threshold value, and the processor is configured to generate the second image by varying a degree of processing between an image of the face region and an image of the body region of the subject.

According to a tenth aspect of the present invention, in the image processing apparatus according to any one of the first aspect to the ninth aspect, it is preferable that the processor is configured to, based on the analyzed scene, acquire an image matching the composition from at least one image group of a first image group or a second image group other than the first image group of a user.

According to an eleventh aspect of the present invention, in the image processing apparatus according to any one of the second aspect to the fifth aspect, it is preferable that a first threshold value and a second threshold value lower than the first threshold value are set as the threshold value, and the processor is configured to determine a first subject greater than or equal to the first threshold value and a second subject greater than or equal to the second threshold value and less than the first threshold value in the first image as the subject, and increase a degree of processing of an image of the second subject with respect to an image of the first subject.

According to a twelfth aspect of the present invention, in the image processing apparatus according to the eleventh aspect, it is preferable that the composition includes a first region in which the image of the first subject is disposed, and a second region in which the image of the second subject is disposed.

According to a thirteenth aspect of the present invention, in the image processing apparatus according to the first aspect, it is preferable that the processor is configured to generate the second image composited by disposing a predetermined number of a plurality of the first images in one region.

According to a fourteenth aspect of the present invention, in the image processing apparatus according to the thirteenth aspect, it is preferable that the processor is configured to generate the second image by changing a degree of processing for the first image corresponding to each frame in accordance with a size of each frame composited as the second image.

According to a fifteenth aspect of the present invention, in the image processing apparatus according to the thirteenth aspect or the fourteenth aspect, it is preferable that the processor is configured to, in a case where the number of first images is smaller than the predetermined number, generate an insufficient image using the first image.

According to a sixteenth aspect of the invention, there is provided an image processing method comprising, via a processor, a step of acquiring a first image including a subject, a step of analyzing a scene of the first image, a step of acquiring composition based on an analysis result of the analyzed scene, and a step of generating a second image based on an image of the subject and the composition.

According to a seventeenth aspect of the invention, there is provided an image processing program causing a computer to implement a function of acquiring a first image including a subject, a function of analyzing a scene of the first image, a function of acquiring composition based on an analysis result of the analyzed scene, and a function of generating a second image based on an image of the subject and the composition.

### BRIEF DESCRIPTION OF THE DRAWINGS

FIG. 1 is a configuration diagram illustrating an image processing system including an image processing apparatus according to an embodiment of the present invention.

FIG. 2 is a functional block diagram illustrating an embodiment of the image processing apparatus according to the embodiment of the present invention.

FIG. 3 is a flowchart illustrating a flow of processing of a subject image extraction unit.

FIG. 4 is a diagram illustrating an example of an image generated by an image generation unit.

FIG. 5 is a graph showing a threshold value set in terms of an “importance degree” and “realness” of a subject.

FIG. 6 is a diagram illustrating an example of an image generated based on composition created by a service provider as an optimal scene.

FIG. 7 is a diagram illustrating an example of a photo product to be printed.

FIG. 8 is a diagram illustrating an example of another photo product to be printed.

FIG. 9 is a flowchart illustrating an embodiment of an image processing method according to the embodiment of the present invention.

### DESCRIPTION OF THE PREFERRED EMBODIMENTS

Hereinafter, preferred embodiments of an image processing apparatus, a method, and a program according to an embodiment of the present invention will be described in accordance with the accompanying drawings.

### Image Processing System

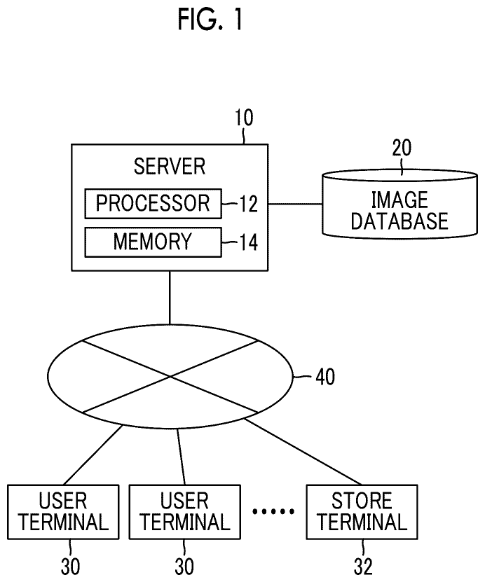

FIG. 1 is a configuration diagram illustrating an image processing system including the image processing apparatus according to the embodiment of the present invention.

The image processing system illustrated in FIG. 1 includes a server 10 functioning as the image processing apparatus, an image database 20, a user terminal 30 communicating with the server 10 through a network 40, and a store terminal 32.

The server 10 is composed of a computer, a workstation, or the like and includes a processor 12, a memory 14, an input/output interface, and the like.

The processor 12 is a part that is composed of a central processing unit (CPU) and the like, controls each unit of the server 10 in an integrated manner, and generates an appealing image. Details of image processing performed by the processor 12 will be described later.

The memory 14 includes a flash memory, a read-only memory (ROM), a random access memory (RAM), a hard disk apparatus, and the like. The flash memory, the ROM, or the hard disk apparatus is a non-volatile memory storing various programs and the like including an operating system and the image processing program for executing the image processing method according to the embodiment of the present invention.

The RAM functions as a work region of processing performed by the processor 12. Various programs stored in the flash memory or the like, data used for operation processing, and the like are temporarily stored. The processor 12 may incorporate a part (the RAM) of the memory 14.

The server 10 is connected to the network 40 such as the Internet and exchanges data with the user terminal 30 and the store terminal through the network 40. The server 10 communicates with the image database 20 and acquires optimal composition from the image database 20.

The image database 20 manages a large number of images that are materials for determining the optimal composition corresponding to a scene, and stores an image group (a first image group) of the user and other image groups (a second image group) other than the image group of the user, such as image groups of other users and an image group for which a print order is placed in the past.

The user terminal 30 includes a smartphone, a laptop computer, or a tablet terminal owned by the user or an imaging apparatus or the like connectable to the network 40. The user terminal 30 can transmit an image of the user (a first image) to the server 10 and receive the appealing image (a second image) generated by the server 10.

The image of the user transmitted from the user terminal 30 to the server 10 may be one static image or an image group including a plurality of static images. The image of the user is an image including a subject. The image of the user is not limited to an image captured by the user, and refers to an image accessible by the user and includes an image stored in a device usable by the user and an image accessible by the user through a network such as cloud storage.

The store terminal 32, in the same manner as the user terminal 30, can also transmit the image of the user to the server 10 through a memory card or the like in which the image of the user is recorded.

The server 10 may have a function of providing a service for storing the image of the user transmitted from the user terminal 30 or a printing service for a photographic print.

### Image Processing Apparatus

### <Embodiment of Image Processing Apparatus>

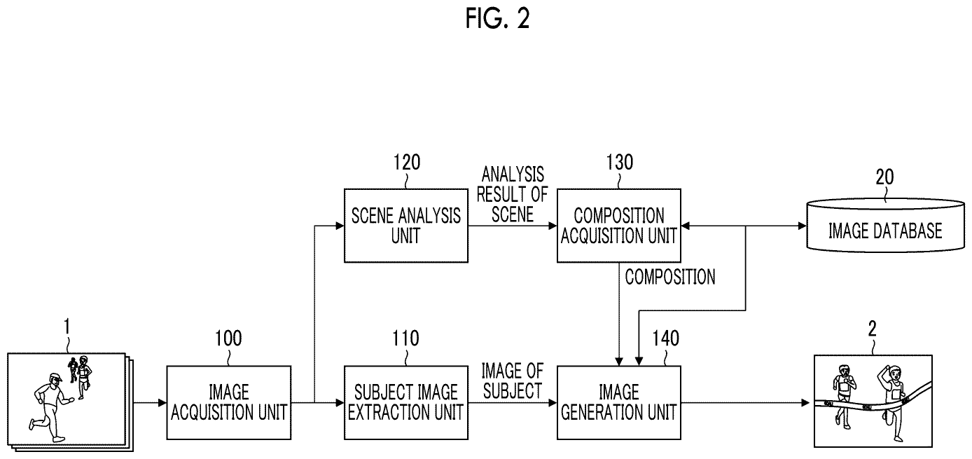

FIG. 2 is a functional block diagram illustrating an embodiment of the image processing apparatus according to the embodiment of the present invention.

FIG. 2 is a functional block diagram mainly illustrating functions of the processor 12 of the server 10 functioning as the image processing apparatus illustrated in FIG. 1.

The processor 12 illustrated in FIG. 2 comprises an image acquisition unit 100, a subject image extraction unit 110, a scene analysis unit 120, a composition acquisition unit 130, and an image generation unit 140.

As described above, the image acquisition unit 100 acquires the image of the user from the user terminal 30 or the store terminal. In the present example, the image acquisition unit 100 acquires an image group 1 of the user including a plurality of static images. The image group 1 of the user in the present example is a plurality of images captured on a field day. However, the image group of the user is not limited to this.

The subject image extraction unit 110 is a part that extracts an image of the subject included in the image group 1 of the user. The image of the subject extracted by the subject image extraction unit 110 is an image of one or more subjects having an importance degree greater than or equal to a threshold value. Here, the subject includes at least one of an object such as a person, a car, an animal, or a building, or a background included in the image. The object refers to an object having a contour. The background refers to a region not belonging to the object in the image. A region of a sky such as a blue sky or a sunset sky, or the like is a typical example of the background. The image of the subject may be a region occupied by the subject in the input image, its surrounding region, or the image itself.

In a case where the image group 1 of the user is a plurality of images captured on the field day, it is considered that a family captures a person such as their child participating in the field day.

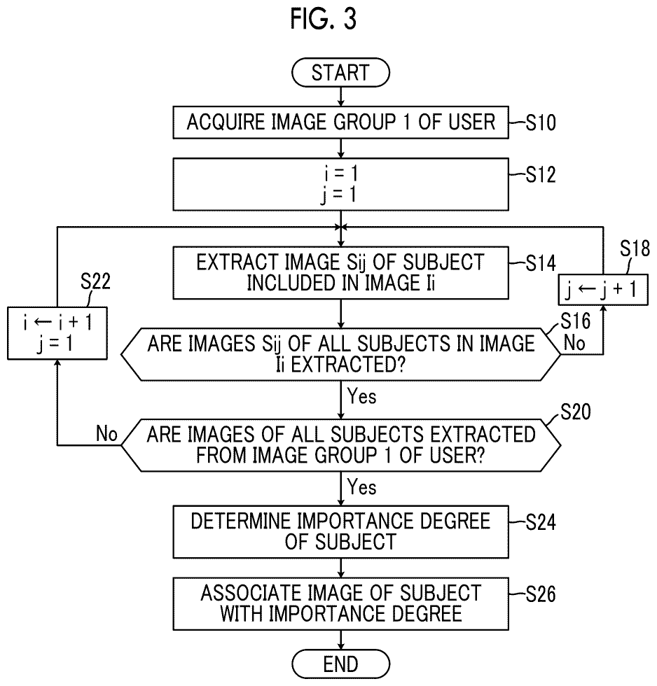

FIG. 3 is a flowchart illustrating a flow of processing of the subject image extraction unit.

In accordance with the flowchart illustrated in FIG. 3, the subject image extraction unit 110 extracts the image of the subject included in each image from the image group 1 of the user and associates the extracted image of the subject with the importance degree.

In FIG. 3, the image group 1 of the user is acquired (step S10). Next, a parameter i indicating an image included in the image group 1 of the user is set to 1, and a parameter j indicating the subject in the image is set to 1 (step S12).

Next, an image Sij of the subject included in an image Ii of the image group 1 of the user is extracted (step S14).

Whether or not the images Sij of all subjects in the image Ii are extracted is determined (step S16). In a case where the images of all subjects in the image Ii are not extracted (in the case of “No”), the parameter j indicating the subject is incremented by 1 (step S18), and a transition is made to step S14. Meanwhile, in a case where the images of all subjects in the image Ii are extracted (in the case of “Yes”), a transition is made to step S20.

Next, whether or not the images of all subjects are extracted from the image group 1 of the user is determined (step S20). In a case where the images of all subjects are not extracted from the image group 1 of the user (in the case of “No”), the parameter i indicating the image is incremented by 1, and the parameter j indicating the subject is set to 1 (step S22). Then, a transition is made to step S14.

In a case where the images of all subjects are extracted from the image group 1 of the user (in the case of “Yes”), a transition is made to step S24.

Accordingly, the images of all subjects are extracted from the image group 1 of the user, and the image of each subject is identifiable by the parameters i and j.

Next, the extracted images of all subjects are classified for each subject. For example, the number of images of subjects of high interest for an image capturing person who performs imaging on the field day is large, and the number of images of subjects captured by chance is small. Accordingly, the importance degree of the subject is determined by the number of images including the same subject (the number of images of the same subject) in the image group 1 of the user or is determined by a ratio of an occurrence frequency or the like of the same subject in the image group 1 of the user (step S24). For example, as the number of images including the same subject in the image group 1 of the user is increased, or as the ratio of the occurrence frequency of the same subject is increased, the importance degree of the subject can be set to be increased. The importance degree of the subject can be determined in accordance with an area or a position of the image of the subject in the image.

The importance degree is assigned to the extracted image of each subject, and the image of the subject is associated with the importance degree (step S26).

For people and pets, the same subject refers to the same person and the same pet. Depending on glasses, hats, clothes, a change in a face due to growth, and the like, the same person in actuality may be recognized as different people, or conversely, different people may be recognized as the same person. In this case, both the same person determined in a state of erroneous recognition and the same person determined after the user or the like manually recognizes the person correctly may be included in the “same subject” according to the embodiment of the present invention.

With reference to FIG. 2, the subject image extraction unit 110 outputs the image of each subject that is extracted from the image group 1 of the user and to which the importance degree is assigned, to the image generation unit 140.

Meanwhile, the scene analysis unit 120 analyzes a scene of the image group of the user based on the image group 1 of the user input from the image acquisition unit 100. Here, the scene is a classification of an imaging situation of the image in accordance with a type of the object included in the image or an imaging environment of the image. For example, a person, a plant, a landscape, food, a night view, sunset, and backlight can be included in the scene. The scene may be determined from the image itself, or the imaging environment of the image such as an imaging time point, an imaging place, and an imaging angle may be acquired from accessory information of the image, and the scene may be determined from the imaging environment. These types of determination of the scene can be executed by a computer using a well-known technique.

In the present example, since the image group 1 of the user is images captured on the field day, the scene analysis unit 120 analyzes the scene of the field day and further analyzes, for example, a scene such as a scene of a footrace, a scene of cornhole, and a scene of a tug of war for each image. The scene analysis unit 120 can analyze the scene using, for example, artificial intelligence (AI).

An analysis result of the scene of the scene analysis unit 120 is output to the composition acquisition unit 130.

The composition acquisition unit 130 acquires an image (composition) having the optimal composition for the analyzed scene from an image group of at least one of the first image group or the second image group other than the first image group of the user stored in the image database 20 based on the analysis result of the analyzed scene. The composition acquisition unit 130 can acquire the optimal composition corresponding to the scene using a learning model that has learned the optimal composition corresponding to the scene.

For example, in a case where a scene recognition result indicates a scene of the footrace on the field day, the composition acquisition unit 130 determines an optimal scene in the scene of the footrace on the field day and acquires composition corresponding to the optimal scene from the image database 20.

That is, the composition acquisition unit 130 determines that a “moment of finish” is the optimal scene from the “scene of footrace on the field day” and acquires the composition of the optimal scene from a large number of images of the “moment of finish” stored in the image database 20, or determines the optimal scene from a large number of images for which a print order is placed as the “scene of the footrace on the field day” and acquires the composition of the determined optimal scene.

Even in the scene of the field day, the optimal scene varies depending on a type of a game of the field day.

The composition acquired by the composition acquisition unit 130 is output to the image generation unit 140.

The image generation unit 140 generates a new appealing and attractive image (the second image) 2 based on the image of each subject that is extracted by the subject image extraction unit 110 and to which the importance degree is assigned, and on the composition acquired by the composition acquisition unit 130.

For example, in a case where composition of a person in first place cutting a finish line tape and a person in second place is acquired as composition of the “moment of finish”, the image generation unit 140 applies, as the person in first place, an image of the most important subject (person) among the images of each subject to which the importance degree is assigned, and applies, as the person in second place, an image of the second most important subject (person) among the images of each subject to which the importance degree is assigned.

Accordingly, the image of the most important person is an image of a “child of the image capturing person” that is an imaging target, and the image of the second most important person corresponds to a person, for example, a “friend”, of which the number of images is not as many as that of the “child of the image capturing person” and who is captured in several images. Whether or not the “child of the image capturing person” and the “friend” participate in the same footrace does not matter.

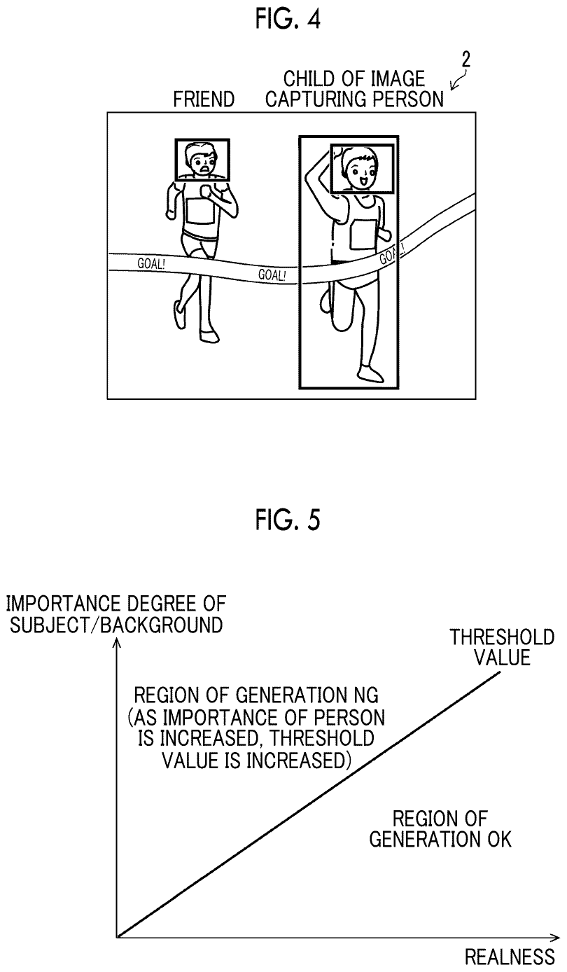

FIG. 4 is a diagram illustrating an example of the image generated by the image generation unit.

In applying the image of the subject to the composition, the image generation unit 140 adjusts a degree of change in the image of the subject in accordance with the importance degree of the subject.

In a case where the subject is a person having a high importance degree, the image of the subject to be included in the image to be generated is generated based on a plurality of images of the subject among a plurality of images including the subject included in the image group of the user. In the present example, the image of the “child of the image capturing person” is changed based on as many images as possible extracted from the image group 1 of the user to prevent a sense of incongruity. Meanwhile, the image of the “friend” having a slightly low importance degree is generated based on several images extracted from the image group 1 of the user. In a case where other people are included in the composition, images of the other people may be generated from captured images of other people. The degree of change in the other subject is also adjusted in accordance with the importance degree of the subject.

That is, a first threshold value and a second threshold value lower than the first threshold value can be set as a threshold value, and the image generation unit 140 can determine the first subject greater than or equal to the first threshold value and the second subject greater than or equal to the second threshold value and less than the first threshold value in the image of the user as the subject, and increase the degree of processing for an image of the second subject with respect to an image of the first subject. For example, the first subject corresponds to the “child of the image capturing person”, and the second subject corresponds to the “friend”. The degree of processing for the image of the “friend” can be set to be higher than that of the image of the “child of the image capturing person”. As illustrated in FIG. 4, the composition includes a first region in which the image of the “child of the image capturing person” of the first subject is disposed, and a second region in which the image of the “friend” of the first subject is disposed.

By disposing the image of the “child of the image capturing person” in the first region and disposing the image of the “friend” in the second region of the composition, and appropriately processing the images, the appealing image 2 at the moment of the “child of the image capturing person” cutting the finish line tape in first place can be generated, as illustrated in FIG. 4. The image of such a scene is ideal and is not an image of a scene that is actually present.

In FIG. 4, a threshold value, described later, is changed in accordance with the subject.
Face of the child: high threshold value
Body/pose of the child: medium threshold value
Other (the background and the like): low threshold value

In a case where the subject is a person, it is preferable to generate the image by setting different threshold values between a face region of the subject and a body region other than the face region in the image of the user and setting different degrees of processing between an image of the face region and an image of the body region of the subject.

FIG. 5 is a graph showing the threshold value set in terms of the “importance degree” and “realness” of the subject.

Here, the “realness” represents a degree of processing for the image of the subject. As the “realness” is increased, the degree of processing for the image of the subject is reduced, and a degree to which use of the images of other people or the like is not allowed is increased.

For example, in the case of replacing the image of the subject with other images, or in the case of erasing the image of the subject, the processing for the image of the subject can be strong processing. Processing of changing a pose or a facial expression of the subject such as a person can be processing of a medium degree. Processing of changing a direction of a visual line, a direction of the face, a hairstyle, or the like can be weak processing. In a case where an image of the “face” is applied as it is (in a case where the image is not processed), the degree of processing is lowest with respect to the “face”, and the “realness” (likeliness to the face of the person) is highest.

As illustrated in FIG. 5, the threshold value is set in accordance with the importance degree of the subject/background. That is, as the importance degree of the subject/background is increased, a value set for the threshold value is increased.

In FIG. 5, a range less than or equal to the threshold value is a region in which the appealing image can be generated. For example, as the importance degree of the subject/background is increased (the threshold value is increased), the “realness” is required. As the importance degree of the subject/background is decreased (the threshold value is decreased), the “realness” is not required, and an allowable range of processing of the image of the subject is expanded.

In the present example, for the “face of the child”, a high threshold value is set, and the image of the person is applied. Accordingly, an image without the sense of incongruity is obtained. A slight change such as a change in the direction of the face is allowed in accordance with the composition. For the “body/pose of the child”, a medium threshold value is set. The image of the child does not have to be applied, and a change in the pose or the like is allowed in accordance with the composition. For “other” such as the background, a low threshold value is set. The “realness” is not required, and any changes can be made.

As the importance degree of the subject is increased, the processing of the image of the subject is reduced in order not to lose the “realness”. While the child of the image capturing person has a high importance degree, for example, clothing of the person may be processed stronger than other people having a low importance degree to look splendid. In a case where the processing of the face of the person is reduced, the sense of incongruity is prevented while making the clothing or the like look splendid. Accordingly, an appealing and attractive image can be obtained.

### <Scene of Talent Show>

In a case where an image obtained by a parent by imaging a child at a talent show is used as the image of the user, an image in which the child of the image capturing person is captured in a small size as one of many children may be captured, and such an image is not an appealing image. Ideally, an image in which the child of the image capturing person is imaged in a large size is an appealing image.

In this case, for example, composition in which a main character occupying a large area is acting in front of many children is acquired, and an appealing image in which an image of the “child of the image capturing person” is applied instead of the main character is generated.

### <Scene of Park>

In a case where an image obtained by a parent by imaging a child of the parent in a park is used as the image of the user, the child may be facing backward, or the parent may not be captured. Ideally, an image in which three people including parents and the child looking at the camera are captured in the park is an appealing image.

In this case, the composition of the optimal scene of three people is acquired, and an appealing image in which an image of three people including the parents and the child looking at the camera is applied using the same park as a background is generated. Images of faces of the parents and the child are not limited to images captured in the park, and images extracted from the image group of the user may be applied.

### <Using Composition in Which Optimal Scene is Customized by Service Provider>

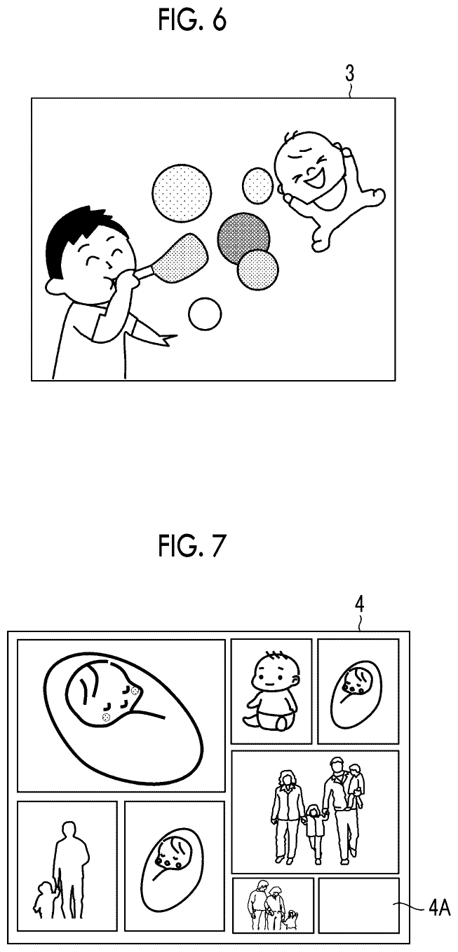

FIG. 6 is a diagram illustrating an example of an image generated based on composition created by a service provider as the optimal scene.

The service provider applies composition in which the optimal scene is customized.

In a case where there is an image of a scene of playing with a soap bubble as the image of the user, and the importance degree of the scene of playing with the soap bubble is high, the composition of the optimal scene of the soap bubble created by the service provider may be acquired.

By applying the image of the subject included in the image of the user to the above composition, an appealing image 3 as illustrated in FIG. 6 can be generated. That is, as illustrated in FIG. 6, the scene to be customized may have composition not present in actuality (composition in which a child is floating like a soap bubble), and an image that cannot be captured in actuality may be generated by prioritizing “appeal”. Such composition can be acquired by learning images processed by other people or the service provider in accordance with the scene.

FIG. 7 is a diagram illustrating an example of a photo product.

The processor 12 of the server 10 can generate an image of a photo product 4 (the second image) composited by disposing a predetermined number of (in the present example, eight) images of the user in one region.

The processor 12 can generate the image of the photo product 4 by changing the degree of processing for each image corresponding to each frame in accordance with a size of each frame composited as the image of the photo product 4. That is, the appeal can be changed in accordance with the size of the frame, and it is preferable to reduce the “realness” of an image of a small frame and increase the “realness” of an image of a large frame. For the image of the small frame, reducing the “realness” can be allowed because the sense of incongruity is small.

In a case where there are only seven images of the user for the photo product 4, the number of images to be used for composition is insufficient. In this case, the processor 12 preferably generates the image of the remaining one frame (a blank frame 4A in FIG. 7) from one or more images among the seven images.

It is preferable to reduce the “realness” in a case where the number of small frames is insufficient, and increase the “realness” in a case where the number of large frames is insufficient.

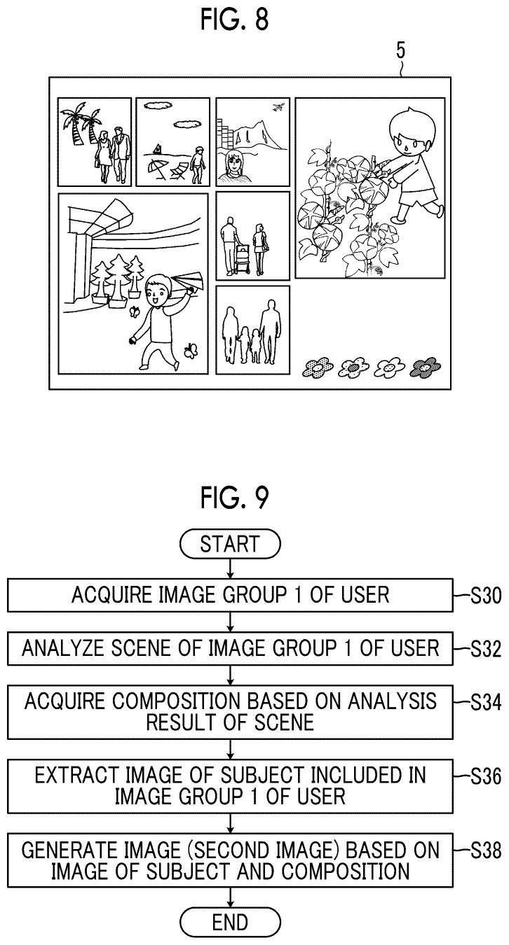

FIG. 8 is a diagram illustrating an example of another photo product.

As illustrated in FIG. 8, the processor 12 can generate “composite data” instead of the “image”. That is, one piece of composite data 5 including a background mount can be generated. In this case, the appeal can be changed in accordance with sizes of frames of the composite data 5 as described above, and it is preferable to reduce the “realness” of a small frame and increase the “realness” of a large frame.

### Image Processing Method

FIG. 9 is a flowchart illustrating an embodiment of the image processing method according to the embodiment of the present invention and illustrates a processing procedure of each unit performed by the processor 12 of the server 10 functioning as the image processing apparatus illustrated in FIG. 2.

In FIG. 9, the image acquisition unit 100 of the processor 12 acquires the image group 1 of the user (step S30).

Next, the scene analysis unit 120 analyzes the scene of the image group of the user based on the image group 1 of the user acquired in step S30 (step S32). The scene analysis unit 120 can analyze the scene using AI.

The composition acquisition unit 130 acquires the optimal composition for the analyzed scene from the image database 20 based on the analysis result of the analyzed scene (step S34). In the present example, in a case where the scene recognition result indicates a scene of the footrace on the field day, composition of the “moment of finish” can be acquired as the optimal composition corresponding to the scene.

Meanwhile, the subject image extraction unit 110 extracts the image of the subject included in the image group 1 of the user from the image group 1 of the user acquired in step S30 (step S36). The subject image extraction unit 110 associates the extracted image of the subject with the importance degree. The importance degree of the subject is determined for each subject using the number of images including the same subject in the image group 1 of the user, the ratio of the occurrence frequency of the same subject in the image group 1 of the user, or the like.

Next, the image generation unit 140 generates the new appealing and attractive image (the second image) 2 based on the image of each subject that is extracted in step S36 and to which the importance degree is assigned, and on the composition acquired in step S34 (step S38).

It is preferable that the image generation unit 140 adjusts a method of generating the image in accordance with the importance degree of each subject. For the image of the subject having a high importance degree of the subject, it is preferable to reduce the degree of processing for the image of the subject to prevent loss of the “realness” and prevent the sense of incongruity with respect to the reality. Meanwhile, for the image of the subject having a low importance degree of the subject, it is preferable to make an adjustment prioritizing the appeal by providing a range of the degree of processing for the image of the subject.

### Other

While the server 10 functions as the image processing apparatus according to the embodiment of the present invention in the present embodiment, the present invention is not limited to this, and other apparatuses such as the user terminal 30 may function as the image processing apparatus according to the embodiment of the present invention.

In the present embodiment, for example, the following various processors may be used as a hardware structure of a processing unit that executes various types of processing, such as the processor 12 of the server 10. The various processors include a central processing unit (CPU) that is a general-purpose processor functioning as various processing units by executing software (a program), a programmable logic device (PLD) such as a field programmable gate array (FPGA) that is a processor having a circuit configuration changeable after manufacture, a dedicated electric circuit such as an application specific integrated circuit (ASIC) that is a processor having a circuit configuration dedicatedly designed to execute specific processing, and the like.

One processing unit may be composed of one of the various processors or may be composed of two or more processors of the same type or different types (for example, a plurality of FPGAs or a combination of a CPU and an FPGA). A plurality of processing units may be composed of one processor. A first example of the plurality of processing units composed of one processor is, as represented by a computer such as a client and a server, one processor composed of a combination of one or more CPUs and software, in which the processor functions as the plurality of processing units. A second example is, as represented by a system on chip (SoC) and the like, use of a processor that implements functions of the whole system including the plurality of processing units in one integrated circuit (IC) chip. Accordingly, various processing units are composed of one or more of the various processors as their hardware structures.

The hardware structure of the various processors is more specifically an electric circuit (circuitry) in which circuit elements such as semiconductor elements are combined.

The present invention also includes the image processing program that is installed on a computer to cause the computer to function as the image processing apparatus according to the embodiment of the present invention, and a non-volatile storage medium on which the image processing program is recorded.

The present invention is not limited to the above embodiments and can be subjected to various modifications without departing from the spirit of the present invention.

### EXPLANATION OF REFERENCES

1: image group of user
2, 3: image
4: photo product
4A: frame
5: composite data
10: server
12: processor
14: memory
20: image database
30: user terminal
32: store terminal
40: network
100: image acquisition unit
110: subject image extraction unit
120: scene analysis unit
130: composition acquisition unit
140: image generation unit
S10 to S38: step

What is claimed is:

1. An image processing apparatus comprising:
a processor; and
a memory storing a program to be executed by the processor,
wherein the processor is configured to:
acquire a first image including a subject;
analyze a scene of the first image;
acquire composition based on an analysis result of the analyzed scene; and
generate a second image based on an image of the subject and the composition.

2. The image processing apparatus according to claim 1,
wherein the subject is one or more subjects having an importance degree greater than or equal to a threshold value.

3. The image processing apparatus according to claim 2,
wherein the first image is a first image group.

4. The image processing apparatus according to claim 2,
wherein the first image is a first image group of a user, and
the importance degree varies depending on the number of images including the same subject, a ratio of an occurrence frequency, or the subject in the first image group.

5. The image processing apparatus according to claim 2,
wherein different values of the threshold value are set depending on the importance degree.

6. The image processing apparatus according to claim 1,
wherein the processor is configured to generate the second image by changing a degree of processing for the image of the subject in accordance with an importance degree of the subject.

7. The image processing apparatus according to claim 2,
wherein a value set for the threshold value is increased as the importance degree of the subject is increased, and
the processor is configured to generate the second image by reducing a degree of processing for the image of the subject, as the importance degree of the subject is increased.

8. The image processing apparatus according to claim 3,
wherein the processor is configured to, in a case where the subject is a person having a high importance degree, generate the image of the subject included in the second image based on a plurality of images of the subject among a plurality of images including the subject included in the first image group.

9. The image processing apparatus according to claim 2,
wherein, in a case where the subject is a person, different threshold values between a face region and a body region other than the face region of the subject of the first image are set as the threshold value, and
the processor is configured to generate the second image by varying a degree of processing between an image of the face region and an image of the body region of the subject.

10. The image processing apparatus according to claim 1,
wherein the processor is configured to, based on the analyzed scene, acquire an image matching the composition from at least one image group of a first image group or a second image group other than the first image group of a user.

11. The image processing apparatus according to claim 2,
wherein a first threshold value and a second threshold value lower than the first threshold value are set as the threshold value, and
the processor is configured to:
determine a first subject greater than or equal to the first threshold value and a second subject greater than or equal to the second threshold value and less than the first threshold value in the first image as the subject; and
increase a degree of processing of an image of the second subject with respect to an image of the first subject.

12. The image processing apparatus according to claim 11,
wherein the composition includes a first region in which the image of the first subject is disposed, and a second region in which the image of the second subject is disposed.

13. The image processing apparatus according to claim 1,
wherein the processor is configured to generate the second image composited by disposing a predetermined number of a plurality of the first images in one region.

14. The image processing apparatus according to claim 13,
wherein the processor is configured to generate the second image by changing a degree of processing for the first image corresponding to each frame in accordance with a size of each frame composited as the second image.

15. The image processing apparatus according to claim 13,
wherein the processor is configured to, in a case where the number of first images is smaller than the predetermined number, generate an insufficient image using the first image.

16. An image processing method comprising:
via a processor,
a step of acquiring a first image including a subject;
a step of analyzing a scene of the first image;
a step of acquiring composition based on an analysis result of the analyzed scene; and
a step of generating a second image based on an image of the subject and the composition.

17. A non-transitory, computer-readable tangible recording medium on which a program for causing, when read by a computer, a processor of the computer to execute the image processing method according to claim 16 is recorded.
